(19) United States
(12) Patent Application Publication
(10) Pub. No.: US 2024/0210534 A1
(43) Pub. Date: Jun. 27, 2024

(54) PHOTOELECTRIC CONVERSION DEVICE AND SIGNAL PROCESSING DEVICE

(71) Applicant: CANON KABUSHIKI KAISHA, Tokyo (JP)

(72) Inventors: HARUNA IIDA, Tokyo (JP); TOSHIKI TSUBOI, Tokyo (JP); KAZUYUKI SHIGETA, Tokyo (JP)

(21) Appl. No.: 18/538,493

(22) Filed: Dec. 13, 2023

(30) Foreign Application Priority Data
Dec. 23, 2022 (JP) 2022-206410

(51) Int. Cl. G01S 7/4863; G01S 7/497; G01S 17/10; G01S 17/89

(52) U.S. Cl. CPC G01S 7/4863; G01S 7/497; G01S 17/10; G01S 17/89

(57) ABSTRACT

A photoelectric conversion device includes: a plurality of photoelectric conversion elements; an acquisition unit configured to acquire a micro-frame constituted by a one-bit signal based on incident light to each of the plurality of photoelectric conversion elements; a compositing unit configured to composite a plurality of the micro-frames to generate a sub-frame constituted by a multi-bit signal; and an attribute information addition unit configured to add, to the sub-frame, attribute information corresponding to an acquisition condition of the sub-frame. Acquisition conditions of at least two sub-frames among a plurality of sub-frames used for one ranging frame are different from each other.

### BACKGROUND OF THE INVENTION

### Field of the Invention

The present invention relates to a photoelectric conversion device and a signal processing device.

### Description of the Related Art

Japanese Patent Application Laid-Open No. 2020-112443 discloses a ranging device that measures a distance to an object by emitting light from a light source and receiving light including reflected light from the object by a light receiving element. In the ranging device disclosed in Japanese Patent Application Laid-Open No. 2020-112443, a single photon avalanche diode (SPAD) element that acquires a signal by multiplying an electron generated by photoelectric conversion is used as a light receiving element. Japanese Patent Application Laid-Open No. 2020-112443 discloses a method of changing a ranging condition in the middle of forming an imaging frame.

In the photoelectric conversion device disclosed in Japanese Patent Application Laid-Open No. 2020-112443, the ranging condition is changed by switching different ranging conditions stored in a register unit in a control unit. The ranging processing unit refers to the ranging condition and uses the ranging condition for the processing. However, such a technique requires communication for sharing the ranging condition between the control unit and the ranging processing unit, which may complicate the device configuration of the photoelectric conversion device.

### SUMMARY OF THE INVENTION

According to a disclosure of the present specification, there is provided a photoelectric conversion device including: a plurality of photoelectric conversion elements; an acquisition unit configured to acquire a micro-frame constituted by a one-bit signal based on incident light to each of the plurality of photoelectric conversion elements; a compositing unit configured to composite a plurality of the micro-frames to generate a sub-frame constituted by a multi-bit signal; and an attribute information addition unit configured to add, to the sub-frame, attribute information corresponding to an acquisition condition of the sub-frame. Acquisition conditions of at least two sub-frames among a plurality of sub-frames used for one ranging frame are different from each other.

According to a disclosure of the present specification, there is provided a signal processing device including: a storage unit configured to store a sub-frame constituted by a multi-bit signal and generated by compositing a plurality of micro-frames constituted by a one-bit signal based on incident light to a photoelectric conversion element; a distance information generation unit configured to generate distance information based on the sub-frame. Attribute information corresponding to an acquisition condition of the sub-frame is added to the sub-frame. Acquisition conditions of at least two sub-frames among a plurality of sub-frames used for one ranging frame are different from each other.

Further features of the present invention will become apparent from the following description of exemplary embodiments with reference to the attached drawings.

### BRIEF DESCRIPTION OF THE DRAWINGS

FIG. 1 is a hardware block diagram illustrating a schematic configuration example of a distance image generation device according to a first embodiment.

FIG. 2 is a schematic view illustrating an overall configuration of a photoelectric conversion device according to the first embodiment.

FIG. 3 is a schematic block diagram illustrating a configuration example of a sensor substrate according to the first embodiment.

FIG. 4 is a schematic block diagram illustrating a configuration example of a circuit substrate according to the first embodiment.

FIG. 5 is a schematic block diagram illustrating a configuration example of one pixel of a photoelectric conversion unit and a pixel signal processing unit according to the first embodiment.

FIG. 6A, FIG. 6B and FIG. 6C are diagrams illustrating an operation of an avalanche photodiode according to the first embodiment.

FIG. 7 is a functional block diagram illustrating a schematic configuration example of the distance image generation device according to the first embodiment.

FIG. 8 is a schematic diagram for explaining ranging frames, sub-frames, and micro-frames according to the first embodiment.

FIG. 9A and FIG. 9B are schematic diagrams illustrating added positions of attribute information according to the first embodiment.

FIG. 10A and FIG. 10B are flowcharts illustrating an operation of the distance image generation device according to the first embodiment.

FIG. 11A and FIG. 11B are flowcharts illustrating an operation of the distance image generation device according to a second embodiment.

FIG. 12A and FIG. 12B are flowcharts illustrating an operation of the distance image generation device according to a third embodiment.

FIG. 13A and FIG. 13B are histograms illustrating a correction method according to the third embodiment.

FIG. 14A and FIG. 14B are schematic diagrams of equipment according to a fourth embodiment.

### DESCRIPTION OF THE EMBODIMENTS

Embodiments of the present invention will now be described with reference to the accompanying drawings. In the drawings, the same or corresponding elements are denoted by the same reference numerals, and the description thereof may be omitted or simplified.

### First Embodiment

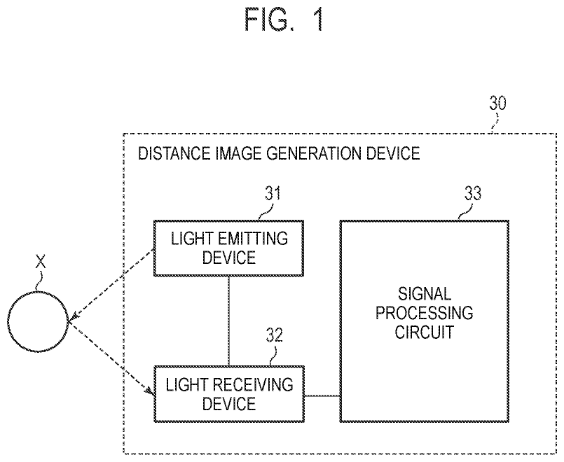

FIG. 1 is a hardware block diagram illustrating a schematic configuration example of a distance image generation device 30 according to the present embodiment. The distance image generation device 30 includes a light emitting device 31, a light receiving device 32, and a signal processing circuit 33. Note that the configuration of the distance image generation device 30 illustrated in the present embodiment is an example, and is not limited to the illustrated configuration.

The distance image generation device 30 is a device for measuring a distance to an object X for the ranging using a technology such as light detection and ranging (LiDAR). The distance image generation device 30 measures the distance from the distance image generation device 30 to the object X based on a time difference until the light emitted from the light emitting device 31 is reflected by the object X and received by the light receiving device 32. Further, the distance image generation device 30 can measure a plurality of points in a two-dimensional manner by emitting laser light to a predetermined ranging area including the object X and receiving reflected light by the pixel array. Thus, the distance image generation device 30 can generate and output a distance image.

The light received by the light receiving device 32 includes ambient light such as sunlight in addition to the reflected light from the object X. For this reason, the distance image generation device 30 performs ranging in which the influence of ambient light is reduced by using a method of measuring incident light in each of a plurality of periods (bin periods) and determining that reflected light is incident in a period in which the amount of light peaks.

The light emitting device 31 emits light such as laser light to the outside of the distance image generation device 30. The signal processing circuit 33 may include a processor that performs arithmetic processing of digital signals, a memory that stores digital signals, and the like. The signal processing circuit 33 may be an integrated circuit such as a field-programmable gate array (FPGA) or an image signal processor (ISP).

The light receiving device 32 generates a pulse signal including a pulse based on the incident light. The light receiving device 32 is, for example, a photoelectric conversion device including an avalanche photodiode as a photoelectric conversion element. In this case, when one photon is incident on the avalanche photodiode and a charge is generated, one pulse is generated by avalanche multiplication. However, the light receiving device 32 may include, for example, a photoelectric conversion element using another photodiode.

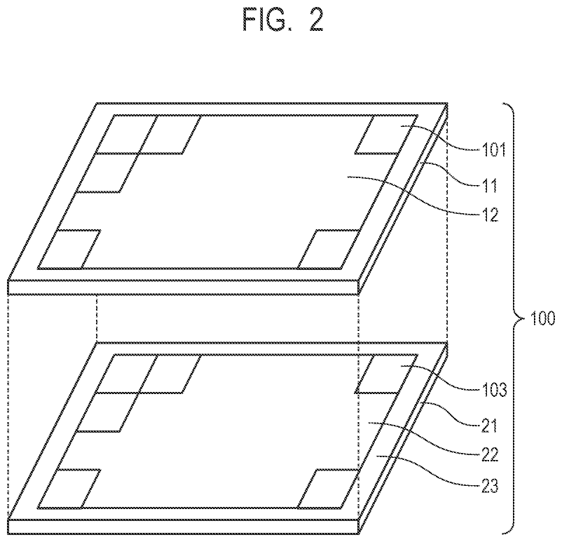

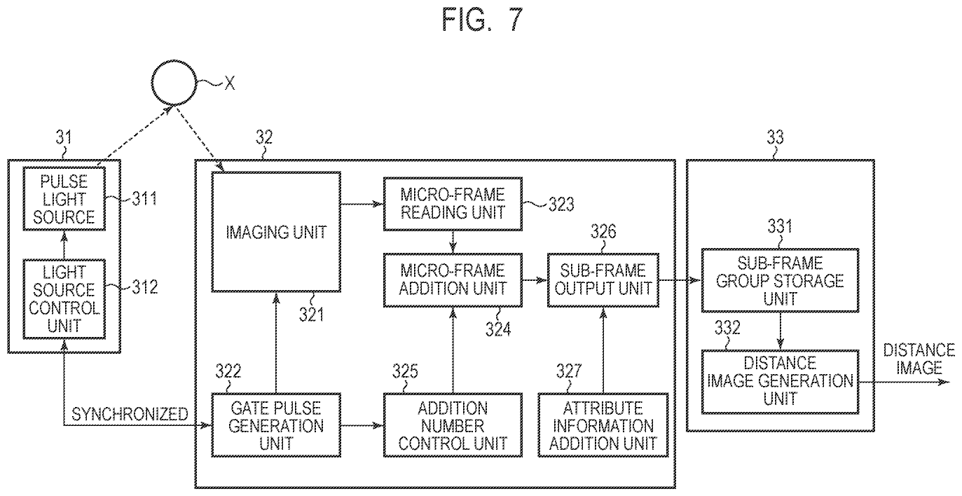

In the present embodiment, the light receiving device 32 includes a pixel array in which a plurality of photoelectric conversion elements (pixels) are arranged to form a plurality of rows and a plurality of columns. A photoelectric conversion device, which is a specific configuration example of the light receiving device 32, will now be described with reference to FIGS. 2 to 6C. The configuration of the photoelectric conversion device described below is an example. The photoelectric conversion device applicable to the light receiving device 32 is not limited thereto, and may be any device as long as it can realize the functions of FIG. 7 described later.

FIG. 2 is a schematic diagram illustrating an overall configuration of the photoelectric conversion device 100 according to the present embodiment. The photoelectric conversion device 100 includes a sensor substrate 11 (first substrate) and a circuit substrate 21 (second substrate) stacked on each other. The sensor substrate 11 and the circuit substrate 21 are electrically connected to each other. The sensor substrate 11 has a pixel region 12 in which a plurality of pixels 101 are arranged to form a plurality of rows and a plurality of columns. The circuit substrate 21 includes a first circuit region 22 in which a plurality of pixel signal processing units 103 are arranged to form a plurality of rows and a plurality of columns, and a second circuit region 23 arranged outside the first circuit region 22. The second circuit region 23 may include a circuit for controlling the plurality of pixel signal processing units 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by being diced after being stacked in a wafer state, or may be manufactured by being stacked after being diced.

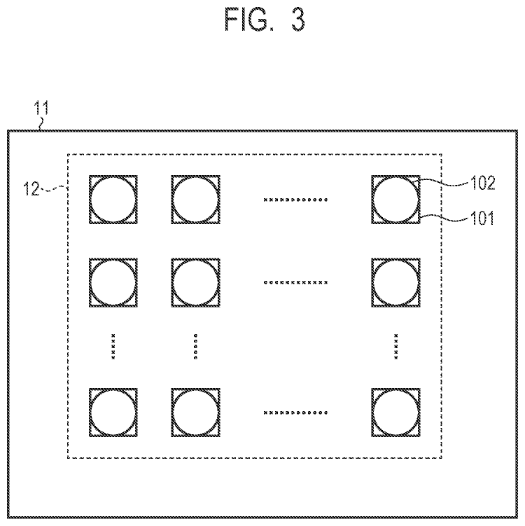

FIG. 3 is a schematic block diagram illustrating an arrangement example of the sensor substrate 11. In the pixel region 12, a plurality of pixels 101 are arranged to form a plurality of rows and a plurality of columns. Each of the plurality of pixels 101 includes a photoelectric conversion unit 102 including an avalanche photodiode (hereinafter referred to as APD) as a photoelectric conversion element in the substrate.

Of the charge pairs generated in the APD, the conductivity type of the charge used as the signal charge is referred to as a first conductivity type. The first conductivity type refers to a conductivity type in which a charge having the same polarity as the signal charge is a majority carrier. Further, a conductivity type opposite to the first conductivity type, that is, a conductivity type in which a majority carrier is a charge having a polarity different from that of a signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is the P-type semiconductor region, and the semiconductor region of the second conductivity type is then N-type semiconductor region. Although the case where one node of the APD is set to a fixed potential is described below, potentials of both nodes may be varied.

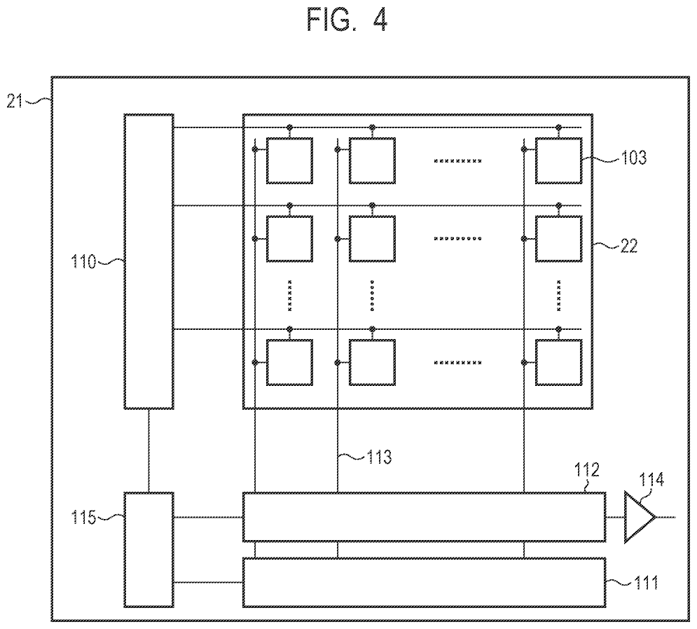

FIG. 4 is a schematic block diagram illustrating a configuration example of the circuit substrate 21. The circuit substrate 21 has the first circuit region 22 in which a plurality of pixel signal processing units 103 are arranged to form a plurality of rows and a plurality of columns.

The circuit substrate 21 includes a vertical scanning circuit 110, a horizontal scanning circuit 111, a reading circuit 112, a pixel output signal line 113, an output circuit 114, and a control signal generation unit 115. The plurality of photoelectric conversion units 102 illustrated in FIG. 3 and the plurality of pixel signal processing units 103 illustrated in FIG. 4 are electrically connected to each other via connection wirings provided for each pixels 101.

The control signal generation unit 115 is a control circuit that generates control signals for driving the vertical scanning circuit 110, the horizontal scanning circuit 111, and the reading circuit 112, and supplies the control signals to these units. As a result, the control signal generation unit 115 controls the driving timings and the like of each unit.

The vertical scanning circuit 110 supplies control signals to each of the plurality of pixel signal processing units 103 based on the control signal supplied from the control signal generation unit 115. The vertical scanning circuit 110 supplies control signals for each row to the pixel signal processing unit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to be output a signal from the pixel signal processing unit 103.

The signal output from the photoelectric conversion unit 102 of the pixels 101 is processed by the pixel signal processing unit 103. The pixel signal processing unit 103 acquires and holds a digital signal having a plurality of bits by counting the number of pulses output from the APD included in the photoelectric conversion unit 102.

It is not always necessary to provide one pixel signal processing unit 103 for each of the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

The horizontal scanning circuit 111 supplies control signals to the reading circuit 112 based on a control signal supplied from the control signal generation unit 115. The pixel signal processing unit 103 is connected to the reading circuit 112 via a pixel output signal line 113 provided for each column of the first circuit region 22. The pixel output signal line 113 in one column is shared by a plurality of pixel signal processing units 103 in the corresponding column. The pixel output signal line 113 includes a plurality of wirings, and has at least a function of outputting a digital signal from the pixel signal processing unit 103 to the reading circuit 112, and a function of supplying a control signal for selecting a column for outputting a signal to the pixel signal processing unit 103. The reading circuit 112 outputs a signal to an external storage unit or signal processing unit of the photoelectric conversion device 100 via the output circuit 114 based on the control signal supplied from the control signal generation unit 115.

The arrangement of the photoelectric conversion units 102 in the pixel region 12 may be one-dimensional. Further, the function of the pixel signal processing unit 103 does not necessarily have to be provided one by one in all the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

As illustrated in FIGS. 3 and 4, the first circuit region 22 having a plurality of pixel signal processing units 103 is arranged in a region overlapping the pixel region 12 in the plan view.

In the plan view, the vertical scanning circuit 110, the horizontal scanning circuit 111, the reading circuit 112, the output circuit 114, and the control signal generation unit 115 are arranged so as to overlap a region between an edge of the sensor substrate 11 and an edge of the pixel region 12. In other words, the sensor substrate 11 includes the pixel region 12 and a non-pixel region arranged around the pixel region 12. In the circuit substrate 21, the second circuit region 23 (described above in FIG. 2) having the vertical scanning circuit 110, the horizontal scanning circuit 111, the reading circuit 112, the output circuit 114, and the control signal generation unit 115 is arranged in a region overlapping with the non-pixel region in the plan view.

Note that the arrangement of the pixel output signal line 113, the arrangement of the reading circuit 112, and the arrangement of the output circuit 114 are not limited to those illustrated in FIG. 3. For example, the pixel output signal lines 113 may extend in the row direction, and may be shared by a plurality of pixel signal processing units 103 in corresponding rows. The reading circuit 112 may be provided so as to be connected to the pixel output signal line 113 of each row.

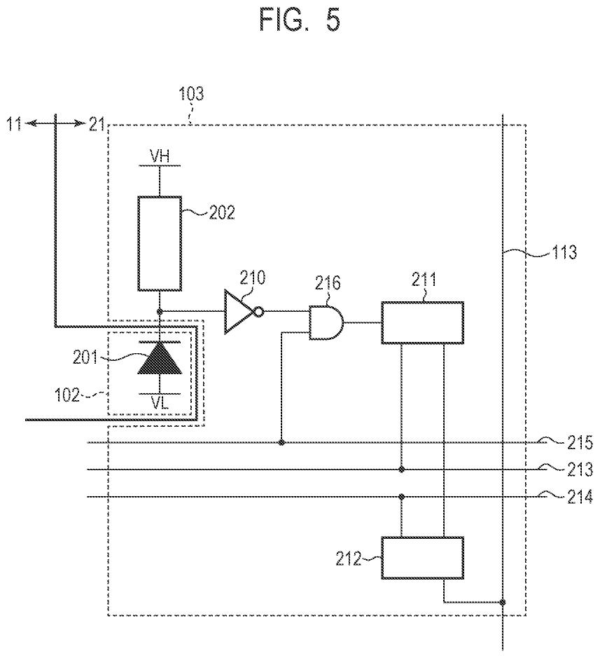

FIG. 5 is a schematic block diagram illustrating a configuration example of one pixel of the photoelectric conversion unit 102 and the pixel signal processing unit 103 according to the present embodiment. FIG. 5 schematically illustrates a more specific configuration example including a connection relationship between the photoelectric conversion unit 102 arranged in the sensor substrate 11 and the pixel signal processing unit 103 arranged in the circuit substrate 21. In FIG. 5, driving lines between the vertical scanning circuit 110 and the pixel signal processing unit 103 in FIG. 4 are illustrated as driving lines 213, 214, and 215.

The photoelectric conversion unit 102 includes an APD 201. The pixel signal processing unit 103 includes a quenching element 202, a waveform shaping unit 210, a counter circuit 211, a selection circuit 212, and a gating circuit 216. The pixel signal processing unit 103 may include at least one of the waveform shaping unit 210, the counter circuit 211, the selection circuit 212, and the gating circuit 216.

The APD 201 generates charges corresponding to incident light by photoelectric conversion. A voltage VL (first voltage) is supplied to the anode of the APD 201. The cathode of the APD 201 is connected to a first terminal of the quenching element 202 and an input terminal of the waveform shaping unit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

The APD operated in the Geiger mode is referred to as a single photon avalanche diode (SPAD). In this case, for example, the voltage VL (first voltage) is −30 V, and the voltage VH (second voltage) is 1 V. The APD 201 may operate in the linear mode or the Geiger mode. In the case of the SPAD, a potential difference becomes greater than that of the APD of the linear mode, and the effect of avalanche multiplication becomes significant, so that the SPAD is preferable.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a resistive element.

The waveform shaping unit 210 shapes the potential change of the cathode of the ADP 201 obtained at the time of photon detection, and outputs a pulse signal. For example, an inverter circuit is used as the waveform shaping unit 210. Although FIG. 5 illustrates an example in which one inverter is used as the waveform shaping unit 210, the waveform shaping unit 210 may be a circuit in which a plurality of inverters are connected in series, or may be another circuit having a waveform shaping effect.

The gating circuit 216 performs gating such that the pulse signal output from the waveform shaping unit 210 passes during a predetermined period. During a period in which the pulse signal can pass through the gating circuit 216, a photon incident on the APD 201 is counted by the counter circuit 211 in the subsequent stage. Accordingly, the gating circuit 216 controls an exposure period during which a signal based on incident light is generated in the pixel 101. The period during which the pulse signal passes is controlled by a control signal supplied from the vertical scanning circuit 110 through the driving line 215. FIG. 5 illustrates an example in which one AND circuit is used as the gating circuit 216. The pulse signal and the control signal are input to two input terminals of the AND circuit. The AND circuit outputs a logical product of those to the counter circuit 211. The gating circuit 216 may have a circuit configuration other than the AND circuit as long as it realizes gating. The waveform shaping unit 210 and the gating circuit 216 may be integrated by using a logic circuit such as a NAND circuit.

The counter circuit 211 counts the pulse signals output from the waveform shaping unit 210 via the gating circuit 216, and holds a digital signal indicating the count value. When a control signal is supplied from the vertical scanning circuit 110 through the driving line 213, the counter circuit 211 resets the held signal. The counter circuit 211 may be, for example, a one-bit counter.

The selection circuit 212 is supplied with a control signal from the vertical scanning circuit 110 illustrated in FIG. 4 through the driving line 214 illustrated in FIG. 5. In response to this control signal, the selection circuit 212 switches between the electrical connection and the non-connection of the counter circuit 211 and the pixel output signal line 113. The selection circuit 212 includes, for example, a buffer circuit or the like for outputting a signal corresponding to a value held in the counter circuit 211.

In the example of FIG. 5, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be arranged at a node such as between the quenching element 202 and the APD 201 or between the photoelectric conversion unit 102 and the pixel signal processing unit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion unit 102 using a switch such as a transistor.

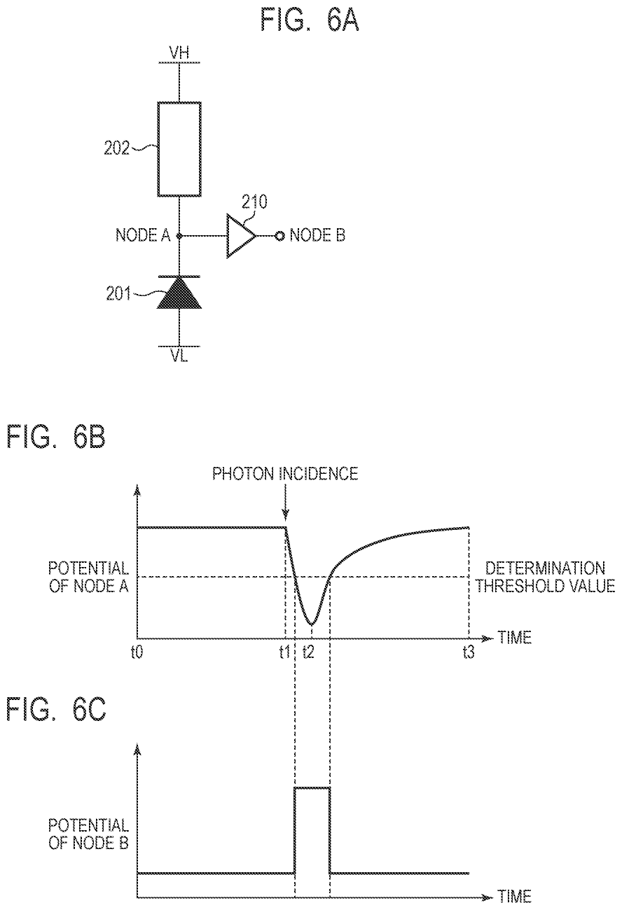

FIGS. 6A, 6B and 6C are diagrams illustrating an operation of the APD 201 according to the present embodiment. FIG. 6A is a diagram illustrating the APD 201, the quenching element 202, and the waveform shaping unit 210 in FIG. 5. As illustrated in FIG. 6A, the connection node of the APD 201, the quenching element 202, and the input terminal of the waveform shaping unit 210 is referred to as node A. Further, as illustrated in FIG. 6A, an output side of the waveform shaping unit 210 is referred to as node B.

FIG. 6B is a graph illustrating a temporal change in the potential of node A in FIG. 6A. FIG. 6C is a graph illustrating a temporal change in the potential of node B in FIG. 6A. During a period from time t0 to time t1, the voltage VH-VL is applied to the APD 201 in FIG. 6A. When a photon is incident on the APD 201 at the time t1, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t2, the avalanche multiplication in the APD 201 stops. Thereby, the voltage level of node A does not drop below a certain constant value. Then, during a period from the time t2 to time t3, a current that compensates for the voltage drop flows from the node of the voltage VH to the node A, and the node A is settled to the original potential at the time t3.

In the above-described process, the potential of node B becomes the high level in a period in which the potential of node A is lower than a certain threshold value. In this way, the waveform of the drop of the potential of the node A caused by the incidence of the photon is shaped by the waveform shaping unit 210 and output as a pulse to the node B.

Next, an overall configuration and operation of the distance image generation device 30 will be described in detail. FIG. 7 is a functional block diagram illustrating a schematic configuration example of the distance image generation device 30 according to the present embodiment. FIG. 7 illustrates a more detailed configuration of the light emitting device 31, the light receiving device 32, and the signal processing circuit 33 described in FIG. 1.

The light emitting device 31 includes a pulse light source 311 and a light source control unit 312. The pulse light source 311 is a light source such as a semiconductor laser device that emits pulse light to an entire ranging area. The pulse light source 311 may be a surface light source such as a surface emitting laser. The light source control unit 312 is a control circuit that controls the light emission timing of the pulse light source 311.

The light receiving device 32 includes an imaging unit 321, a gate pulse generation unit 322, a micro-frame reading unit 323, a micro-frame addition unit 324, an addition number control unit 325, a sub-frame output unit 326, and an attribute information addition unit 327. As described above, the imaging unit 321 may include a pixel array in which pixel circuits each including the APD 201 are two-dimensionally arranged. Thus, the distance image generation device 30 can acquire a two-dimensional distance image.

The gate pulse generation unit 322 is a control circuit that outputs a control signal for controlling the driving timing of the imaging unit 321. The gate pulse generation unit 322 transmits and receives control signals to and from the light source control unit 312, thereby synchronously controlling the pulse light source 311 and the imaging unit 321. This makes it possible to perform imaging in which a time difference from a time at which light is emitted from the pulse light source 311 to a time at which light is received by the imaging unit 321 is controlled. In the present embodiment, it is assumed that the gate pulse generation unit 322 performs a global gate driving of the imaging unit 321. The global gate driving is a driving method in which the incident light is simultaneously detected in the same exposure period in some pixels (pixel groups) in the imaging unit 321 based on the emission time of the pulse light from the pulse light source 311. In the global gate driving of the present embodiment, the incident light is repeatedly detected while sequentially shifting the collective exposure timing. Thus, each pixel of the imaging unit 321 simultaneously generates a one-bit signal indicating the presence or absence of an incident photon in each of a plurality of exposure periods.

This global gate driving is realized by inputting a high-level signal to an input terminal of the gating circuit 216 of each of the plurality of pixels 101 during the gating period based on a control signal from the gate pulse generation unit 322.

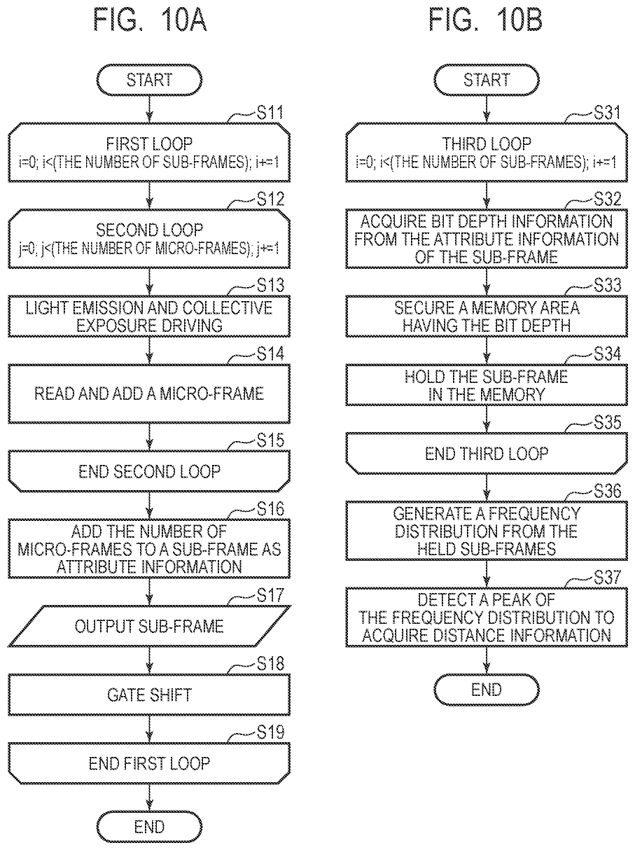

The micro-frame reading unit 323, the micro-frame addition unit 324, and the addition number control unit 325 are signal processing circuits that read out a one-bit signal constituting a micro-frame from the imaging unit 321 and perform predetermined signal processing. The operation of each of these units will be described later in detail with reference to FIG. 10A. The sub-frame output unit 326 is a circuit that outputs a signal including a sub-frame from the light receiving device 32 to the signal processing circuit 33 according to a predetermined standard. The attribute information addition unit 327 generates attribute information corresponding to the acquisition condition and adds the attribute information to the sub-frame output from the sub-frame output unit 326 based on the acquisition condition of the sub-frame in the light emitting device 31 or the light receiving device 32. In the present embodiment, it is assumed that the attribute information is the number of additions of the micro-frames set by the addition number control unit 325, that is, the number of the micro-frames used for compositing the sub-frame. However, the attribute information is not limited thereto, and may include a light emission condition of the light emitting device 31, a light receiving condition of incident light in the light receiving device 32, a compositing condition of micro-frames in the light receiving device 32, and the like. The sub-frame output unit 326 transmits a signal including a sub-frame to which attribute information is added from the memory in the light receiving device 32 to the memory in the signal processing circuit 33. The functions of these units can be realized by the counter circuit 211, the selection circuit 212, and the gating circuit 216 in FIG. 5, and by the reading circuit 112, the output circuit 114, and the like in FIG. 4.

The signal processing circuit 33 includes a sub-frame group storage unit 331 and a distance image generation unit 332. The signal processing circuit 33 is a computer including a processor that operates as the distance image generation unit 332, a memory that operates as the sub-frame group storage unit 331, and the like. The operation of each of these units will be described later with reference to FIG. 10B.

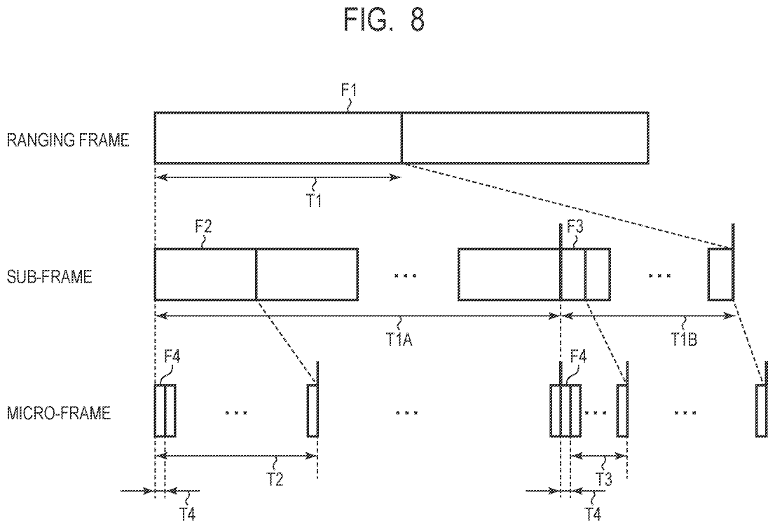

Prior to the description of the driving method of the present embodiment, the configuration of the ranging frame, the sub-frame, and the micro-frame will be described with reference to FIG. 8. FIG. 8 schematically illustrates acquisition periods of the ranging frames corresponding to the distance images, the sub-frames used for generation of the ranging frame, and the micro-frames used for generation of the sub-frame by arranging blocks in the horizontal direction. The horizontal direction in FIG. 8 indicates the elapse of time, and one block indicates the acquisition period of one ranging frame, sub-frame, or micro-frame.

A ranging frame F1 corresponds to one distance image. That is, the ranging frame F1 has information corresponding to the distance to the object X calculated from the time difference from the emission of light to the reception of light for each of the plurality of pixels. In the present embodiment, it is assumed that distance images are acquired as a moving image, and one ranging frame F1 is repeatedly acquired every time one ranging frame period T1 elapses.

One ranging frame F1 is generated from a plurality of sub-frames F2 and a plurality of sub-frames F3. One ranging frame period T1 is divided into a first period T1A and a second period T1B after the first period T1A. The first period T1A includes a plurality of sub-frame periods T2. The second period T1B includes a plurality of sub-frame periods T3. When one sub-frame period T2 elapses, one sub-frame F2 is acquired, and when one sub-frame period T3 elapses, one sub-frame F3 is acquired. The sub-frame F2 is constituted by a multi-bit signal corresponding to the amount of light incident on the sub-frame period T2. The sub-frame F3 is constituted by a multi-bit signal corresponding to the amount of light incident on the sub-frame period T3.

One sub-frame F2 is generated from a plurality of micro-frames F4. One sub-frame period T2 includes a plurality of micro-frame periods T4. One micro-frame F4 is repeatedly acquired every time one micro-frame period T4 elapses. The micro-frame F4 is constituted by a one-bit signal indicating the presence or absence of incident light to the photoelectric conversion element in the micro-frame period T4. By compositing a plurality of micro-frames F4 of one-bit signals, one sub-frame F2 of a multi-bit signal is generated. Thus, one sub-frame F2 can include a multi-bit signal corresponding to the number of micro-frames in which incident light is detected within the sub-frame period T2. In this manner, a plurality of sub-frames F2 in which incident light is acquired in different periods are acquired.

Similarly, one sub-frame F3 is generated from a plurality of micro-frames F4. One sub-frame period T3 includes a plurality of micro-frame periods T4. By compositing a plurality of micro-frames F4 of a one-bit signal, one sub-frame F3 of a multi-bit signals is generated. Thus, one sub-frame F3 can include a multi-bit signal corresponding to the number of micro-frames in which incident light is detected within the sub-frame period T3. In this manner, a plurality of sub-frames F3 in which incident light is acquired in different periods are acquired.

The signal acquisition times of the plurality of sub-frames F2 and F3 can be associated with the distance from the distance image generation device 30 to the ranging target. Then, the signal acquisition time at which the signal value is maximized can be determined from the distribution of the signal acquisition time and the signal values of the plurality of sub-frames F2 and F3. Since it is estimated that the reflected light is incident on the imaging unit 321 at the time when the signal value is the maximum, the distance can be calculated by converting the signal acquisition time when the signal value is the maximum into the distance to the object X. Further, a distance image can be generated by calculating a distance for each pixel and acquiring a two-dimensional distribution of the distance.

As illustrated in FIG. 8, the length of the ranging frame period T1 required to acquire one ranging frame F1 depends on the number of sub-frames F2. Since the number of sub-frames F2 is a parameter corresponding to the number of ranging points, there is a trade-off relationship between the distance resolution and the frame rate.

Here, the number of the micro-frames F4 used for generating one sub-frame F2 and the number of the micro-frames F4 used for generating one sub-frame F3 are different from each other. Thereby, a bit depth of the sub-frame F2 in the first period T1A and a bit depth of the sub-frame F3 in the second period T1B are different from each other. Since the bit depth affects the detection resolution of the amount of incident light, the accuracy of the sub-frame F2 and the accuracy of the sub-frame F3 are different from each other.

FIG. 8 illustrates an example in which the second period T1B is later than the first period T1A and the number of added micro-frames F4 in the second period T1B is less than the number of added micro-frames F4 in the first period T1A. In this example, the first period T1A corresponds to a period during which ranging is performed at a short distance, and the second period T1B corresponds to a period during which ranging is performed at a long distance. Therefore, short-distance ranging is performed with high accuracy by adding a relatively large number of micro-frames F4, and long-distance ranging is performed with low accuracy by adding a relatively small number of micro-frames F4. In this way, ranging using a signal with appropriate accuracy is realized according to the distance, so that both accuracy improvement and frame rate improvement are achieved.

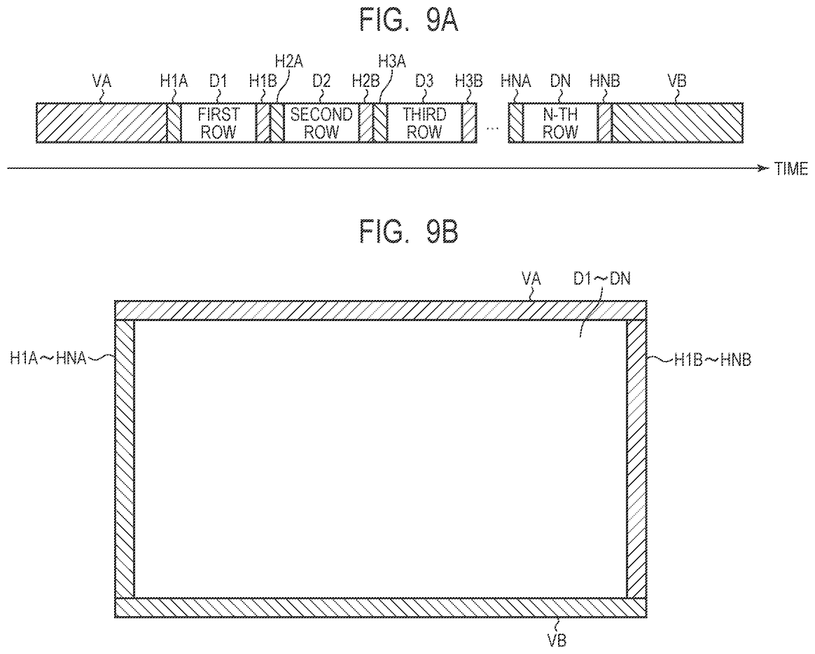

FIGS. 9A and 9B are schematic diagrams illustrating added positions of attribute information according to the present embodiment. FIGS. 9A and 9B illustrate a format of one sub-frame output from the sub-frame output unit 326 to the sub-frame group storage unit 331. FIG. 9A illustrates a data structure of the digital signals constituting the sub-frame in time series, and FIG. 9B illustrates a two-dimensional array in which the digital signals constituting the sub-frame are associated with the pixel array.

In FIGS. 9A and 9B, data D1 to DN represent output signals of pixels in the first row to the N-th row, respectively. The data VA is data that is output in a vertical blanking period before the outputs of the data D1 to DN in one sub-frame period. The data VB is data that is output in a vertical blanking period after the outputs of the data D1 to DN in one sub-frame period. The data H1A to HNA are data that are output in horizontal blanking periods before the outputs of the data D1 to DN of the first to N-th rows, respectively. The data H1B to HNB are data that are output in horizontal blanking periods after the outputs of the data D1 to DN of the first to N-th rows, respectively. In the present embodiment, the attribute information may be included in one or more of the data VA, VB, H1A to HNA, H1B to HNB hatched in FIGS. 9A and 9B. The setting of data including the attribute information can be appropriately set according to the specification of the signal processing circuit 33, the kind of the attribute information, and the like.

Note that a method of adding attribute information at a position corresponding to the blanking period as described above is an example, and the method is not limited thereto. For example, the attribute information may be added before or after a series of data, such as a packet header or a packet footer.

Further, a plurality of different kinds of attribute information may be included in different data among the data VA, VB, H1A to HNA, and H1B to HNB. For example, the data H1A in the first row may be the number of added micro-frames, the data H2A in the second row may be a gate shift amount, the data H3A in the third row may be a light source wavelength, and the data H4A in the fourth row may be a light source intensity. Thus, by storing different kinds of attribute information at different positions, a large number of pieces of information can be included in a sub-frame. Other examples of the attribute information include external environment information of the distance image generation device 30 such as temperature and setting information of the light receiving device 32 such as a gain, an exposure amount, an aperture amount of the lens, and a focus position. These information may also be included in one or more of the data VA, VB, H1A to HNA, H1B to HNB. As described above, since the blanking period includes the attribute information, a large amount of information can be added to the sub-frame while maintaining the amount of output data of the pixel.

FIGS. 10A and 10B are flowcharts illustrating an operation of the distance image generation device 30 according to the present embodiment. FIG. 10A illustrates sub-frame generation processing performed in the light receiving device 32, and FIG. 10B illustrates distance information acquisition processing performed in the signal processing circuit 33.

First, the sub-frame generation processing will be described with reference to FIG. 10A. A first loop from step S11 to step S19 is a process of repeatedly generating a plurality of sub-frames. The first loop includes a second loop from step S12 to step S15. The second loop is a process of generating and adding a plurality of micro-frames to generate one sub-frame. The processing in the first loop (from the step S12 to step S18) is executed as many times as the number of sub-frames, and the processing in the second loop (from step S13 to step S14) is executed as many times as the number of micro-frames.

First, processing in the second loop will be described. In the step S13, the light source control unit 312 controls the pulse light source 311 to emit pulse light within a predetermined ranging area. In synchronization with this, the gate pulse generation unit 322 controls the imaging unit 321 to start detection of incident light by the global gate driving.

In the step S14, the micro-frame reading unit 323 reads a micro-frame from the imaging unit 321 every time a micro-frame period elapses. The read micro-frame is held in a memory of the micro-frame addition unit 324. This memory has a storage capacity capable of holding multi-bit data for each pixel. The micro-frame addition unit 324 sequentially adds a value of the micro-frame to a value held in the memory every time the micro-frame is read out.

The processing of the steps S13 and the processing of the step S14 in the second loop are executed as many times as the number of micro-frames. Thus, the micro-frame addition unit 324 adds a plurality of micro-frames in the sub-frame period to generate a sub-frame. The number of additions in the micro-frame addition unit 324 is controlled by the addition number control unit 325. For this control, the addition number control unit 325 holds setting information of the number of additions. In this way, the micro-frame reading unit 323 functions as an acquisition unit that acquires a micro-frame constituted by a one-bit signal based on incident light to the photoelectric conversion element. The micro-frame addition unit 324 functions as a compositing unit that composites a plurality of micro-frames acquired in different periods. For example, when the number of additions is 64, a sub-frame signal having a 6-bit gradation can be generated by compositing 64 micro-frames.

In the step S16 after the end of the second loop, the attribute information addition unit 327 adds the number of additions of the micro-frames to the sub-frame as attribute information. In the step S17, the sub-frame output unit 326 outputs the sub-frame to which the attribute information is added to the sub-frame group storage unit 331.

In the step S18, the gate pulse generation unit 322 performs processing (gate shift) of shifting the start time of the global gate driving with respect to the light emission time by the length of one sub-frame period. Thereafter, the processing of generation and output of sub-frame is repeated in the same manner. The processing from the step S12 to the step S18 in the first loop is executed as many times as the number of sub-frames. Thus, the sub-frames are repeatedly output from the light receiving device 32 to the signal processing circuit 33.

Next, the distance information acquisition processing will be described with reference to FIG. 10B. A third loop from step S31 to step S35 is a process in which the sub-frame group storage unit 331 holds a plurality of sub-frames. The processing in the third loop (step S32 to step S34) is executed as many times as the number of sub-frames.

First, processing in the third loop will be described. In the step S32, the sub-frame group storage unit 331 reads the attribute information added to the sub-frame output from the sub-frame output unit 326 by the processing of the step S17. This attribute information is the number of additions of the micro-frames, and corresponds to the bit depth of the sub-frame. Therefore, the sub-frame group storage unit 331 can acquire bit depth information.

In the step S33, the sub-frame group storage unit 331 secures a memory area having the number of bits corresponding to the acquired bit depth information. Then, in the step S34, the sub-frame group storage unit 331 holds the sub-frame in the secured memory area. As described above, by acquiring the bit depth information from the sub-frame, an appropriate memory amount can be secured, and one or both of an improvement in computation efficiency and a reduction in power consumption of the signal processing circuit 33 can be realized.

The processing from the step S32 to the step S34 in the third loop is executed as many times as the number of sub-frames. Thus, a plurality of sub-frames output from the sub-frame output unit 326 is held in the sub-frame group storage unit 331.

In the step S36, the distance image generation unit 332 (distance information generation unit) reads a plurality of sub-frames in one ranging frame period from the sub-frame group storage unit 331. Then, the distance image generation unit 332 generates a frequency distribution indicating a relationship between a frequency corresponding to the intensity of the incident light and a gate shift amount (corresponding to a distance) from the acquired plurality of sub-frames.

In the step S36, the distance image generation unit 332 may perform normalization processing of the frequency based on the bit depth. For example, there may be a discrepancy due to a difference in the number of bits in the peak intensity of the frequency distribution between a sub-frame in which the number of accumulations of micro-frames is 64 (up to 6 bits) and a sub-frame in which the number of accumulations of micro-frames is 16 (up to 4 bits). In this example, for a sub-frame to which attribute information indicating that the bit depth is 4 bits is added, this discrepancy can be compensated by multiplying the frequency of the frequency distribution by 4. Thus, by performing the normalization processing of the frequency based on the bit depth, an error caused by the difference in the number of bits between sub-frames can be reduced.

In the step S37, the distance image generation unit 332 calculates a distance corresponding to a sub-frame having a maximum signal value for each pixel from the frequency distribution, thereby generating a distance image indicating a two-dimensional distribution of the distances. Then, the distance image generation unit 332 outputs the distance image to a device outside the signal processing circuit 33. This distance image may be used, for example, to detect a surrounding environment of a vehicle. The distance image generation unit 332 may store the distance image in a memory inside the distance image generation device 30.

According to the present embodiment, attribute information is added to the sub-frame. Thus, when transmission of the sub-frame is performed, it is not necessary to transmit attribute information used when the sub-frame is utilized separately from the sub-frame. As illustrated in FIG. 8, even when the acquisition condition of the sub-frame is changed within one ranging frame period, since the attribute information is added to the sub-frame, the information of the acquisition condition change is transmitted together with the sub-frame. Therefore, since the configuration for transmitting and receiving information is simplified, a photoelectric conversion device and a signal processing device with a simplified device configuration are provided.

### Second Embodiment

In the present embodiment, an example in which the attribute information described in the first embodiment is not the number of micro-frames but a gate shift amount will be described. The description of elements common to those of the first embodiment may be omitted or simplified as appropriate.

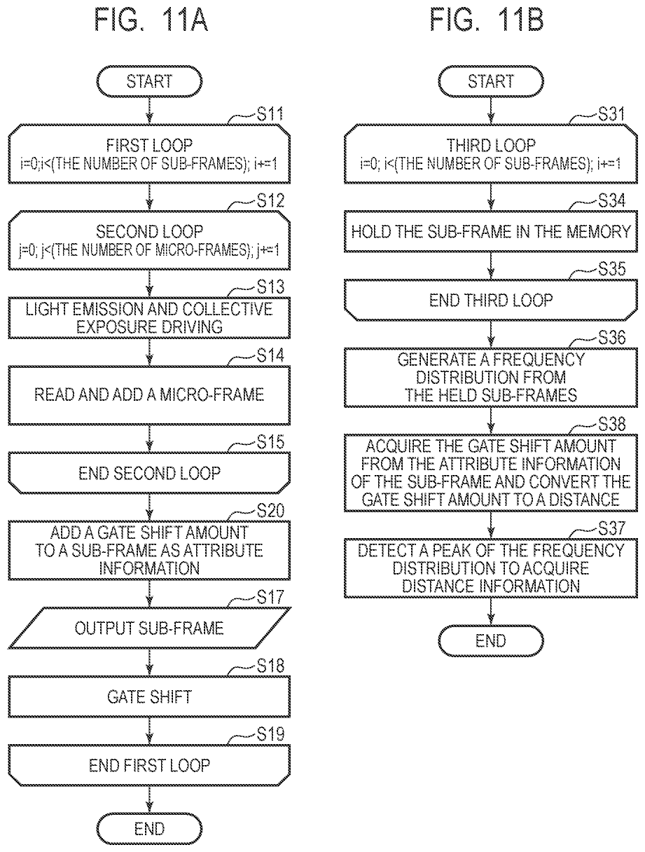

FIGS. 11A and 11B are flowcharts illustrating an operation of the distance image generation device 30 according to the present embodiment. FIG. 11A illustrates sub-frame generation processing performed in the light receiving device 32, and FIG. 11B illustrates distance information acquisition processing performed in the signal processing circuit 33.

In the sub-frame generation processing of FIG. 11A, steps S11 to S15 and steps S17 to S19 are the same as those in the first embodiment, and thus description thereof is omitted. In FIG. 11A, the step S16 of FIG. 10A is replaced with step S20.

In the step S20, the attribute information addition unit 327 adds the gate shift amount set at the time of acquiring the sub-frame, to the sub-frame as the attribute information. The specific value of the gate shift amount may be, for example, a time difference with respect to a predetermined reference time. The predetermined reference time may be, for example, a constant determined according to a clock frequency, or may be a time corresponding to a case where the gate shift amount is zero. The gate shift amount may be a distance calculated from the time difference and the light speed.

In the distance information acquisition processing of FIG. 11B, the step S32 and the step S33 are omitted from that of the first embodiment. This is because in the present embodiment, the number of accumulations of the micro-frames for each of the plurality of sub-frames is constant, and switching of the amount of the memory area according to the attribute information does not occur. In addition, in the present embodiment, step S38 is added between the step S36 and the step S37. Since the other points are similar to those of the first embodiment, the description thereof will be omitted.

In the step S38, the distance image generation unit 332 reads the attribute information added to the sub-frame. This attribute information is the gate shift amount and indicates a correspondence relationship between the sub-frame and the distance. In the step S37, the distance image generation unit 332 can acquire distance information in consideration of the gate shift amount acquired from the attribute information added to the sub-frame.

According to the present embodiment, the attribute information added to the sub-frame is the gate shift amount. Thus, even when a driving method in which the interval of the gate shift amount of a plurality of sub-frames is changed in one ranging frame period is applied, the information of the gate shift amount is transmitted together with the sub-frame without separately transmitting the information. This makes it possible to realize a driving method in which the distance resolution is increased by narrowing the interval of the gate shift amount of the plurality of sub-frames in the short-distance ranging, and the distance resolution is reduced by widening the interval of the gate shift amount of the plurality of sub-frames in the long-distance ranging. This driving method achieves both a high resolution in the short distance and an appropriate frame rate. Even in such a driving method, the distance image generation unit 332 can acquire the distance information appropriately by acquiring the interval of the gate shift amount from the attribute information added to the sub-frame without separately receiving a change in the interval of the gate shift amount.

Note that the attribute information added to the sub-frame may be a length of a period during which the control signal output from the gate pulse generation unit 322 is the high level (light receiving period of incident light). In this case as well, the distance image generation unit 332 can acquire the distance information appropriately by acquiring the length of the light receiving period from the attribute information added to the sub-frame without separately receiving a change in the length of the light receiving period.

### Third Embodiment

In the present embodiment, an example in which the attribute information described in the first embodiment and the second embodiment is not a condition on the light receiving device 32 side but a condition on the light emitting device 31 side (light source information) will be described. Elements common to the first embodiment or the second embodiment may be appropriately omitted or simplified.

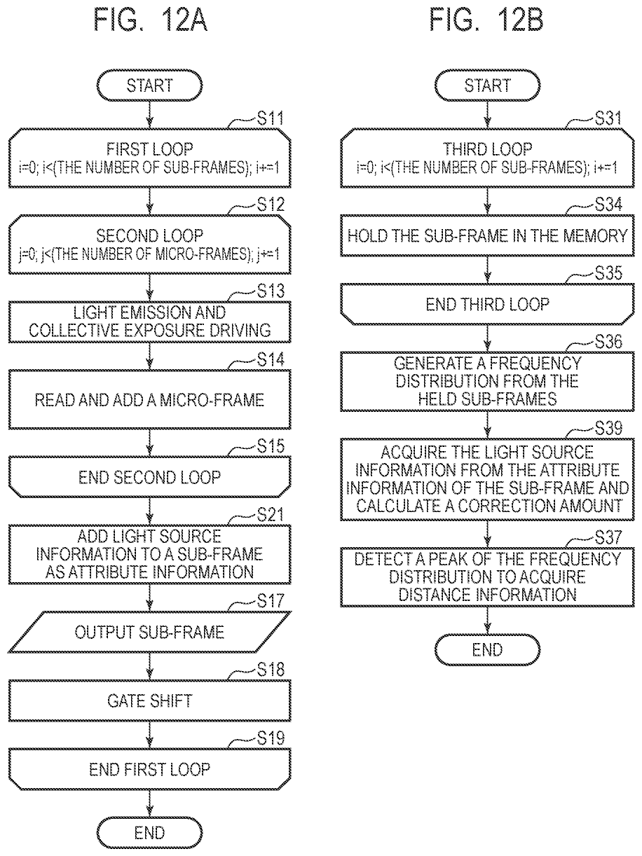

FIGS. 12A and 12B are flowcharts illustrating an operation of the distance image generation device 30 according to the present embodiment. FIG. 12A illustrates sub-frame generation processing performed in the light receiving device 32, and FIG. 12B illustrates distance information acquisition processing performed in the signal processing circuit 33.

In the sub-frame generation processing of FIG. 12A, steps S11 to S15 and steps S17 to S19 are the same as those in the first embodiment, and thus description thereof is omitted. In FIG. 12A, the step S16 in FIG. 10A is replaced with step S21.

In the step S21, the attribute information addition unit 327 adds the light source information set at the time of acquiring the micro-frame to the sub-frame. Specific examples of the light source information include the intensity and wavelength of light emitted from the light source. It is assumed that the light emitting device 31 can switch these emission conditions (for example, emission intensity and emission wavelength). In addition, it is assumed that the light source information is communicated between the light emitting device 31 and the light receiving device 32 and acquired by the attribute information addition unit 327 when the micro-frame is acquired.

Since the light emitting device 31 has such a configuration, the light emitting conditions can be switched depending on the scene. Specifically, it is possible to switch the conditions such that the ranging is performed using a light source having a low light emission intensity in the short-distance ranging, and the ranging is performed using a light source having a high light emission intensity in the long-distance ranging. In addition, in a scene in which there is no fog at a short distance but there is fog at a long distance, it is possible to switch the conditions for changing the emission wavelength according to the distance. By switching the light emission conditions according to the distance as described above, effects such as reduction of power consumption of the light source and reduction of influence on eyes of a subject such as a human can be realized.

In the distance information acquisition processing of FIG. 12B, the step S32 and the step S33 are omitted from that of the first embodiment. This is because in the present embodiment, the number of accumulations of the micro-frames for each of the plurality of sub-frames is constant, and switching of the amount of the memory area according to the attribute information does not occur. In addition, in the present embodiment, step S39 is added between the step S36 and the step S37. Since the other points are similar to those of the first embodiment, the description thereof will be omitted.

In the step S39, the distance image generation unit 332 reads the attribute information added to the sub-frame. This attribute information is light source information, and the distance image generation unit 332 can calculate a correction amount for correcting the frequency of the frequency distribution from the light source information. In the step S37, the distance image generation unit 332 can acquire distance information in consideration of the correction amount acquired from the attribute information added to the sub-frame.

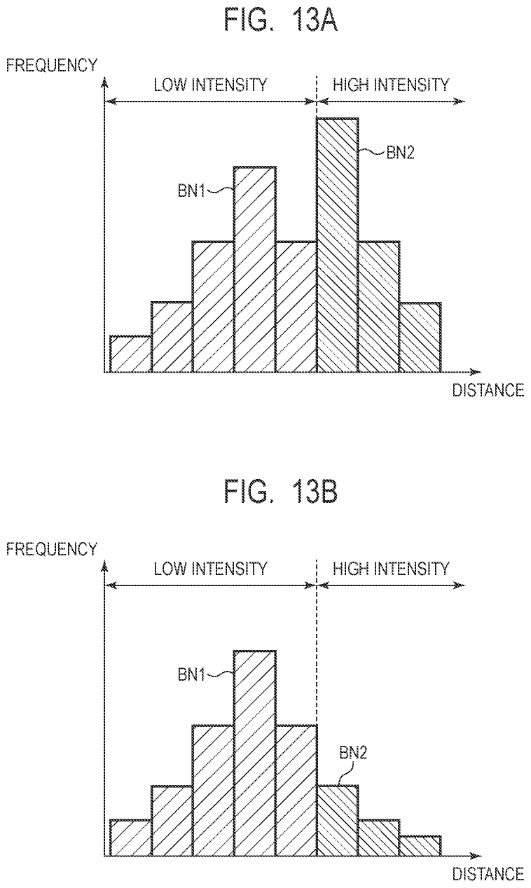

A method of correcting the frequency of the frequency distribution which can be applied to the step S39 and the step S37 will be described below with reference to FIGS. 13A and 13B. FIGS. 13A and 13B are histograms illustrating a correction method according to the present embodiment. FIG. 13A is a histogram illustrating a frequency distribution before correction, and FIG. 13B is a histogram illustrating a frequency distribution after correction.

FIG. 13A illustrates an example of a histogram in the case where processing for increasing the light emission intensity of the light source is performed between the fifth bin and the sixth bin. In this case, the frequency may increase as the emission intensity increases. Thus, in the example of FIG. 13A, the frequencies of the sixth to eighth bins are increased. Therefore, in FIG. 13A, the frequency of the bin BN2 which is a peak in the high intensity region is greater than the frequency of the bin BN1 which is a peak in the low intensity region. When a peak is calculated from this frequency distribution, a distance corresponding to the bin BN2 can be erroneously detected.

Therefore, in the present embodiment, the distance image generation unit 332 acquires the intensity of the light source from the attribute information added to the sub-frame, and corrects the frequency by the correction amount corresponding to the intensity. Thereby, as illustrated in FIG. 13B, correction is performed to compensate for the difference in intensity of the light source by reducing the frequency of the high intensity region. Thereby, since the frequency of the bin BN1, which is a true peak, is maximized in the whole, the peak can be appropriately detected. Thus, the detection accuracy of the peak can be improved.

According to the present embodiment, the attribute information added to the sub-frame is the light source information. Thus, even when a driving method in which the light emission condition at the time of acquisition of a plurality of sub-frames are changed in one ranging frame period is applied, the light source information is transmitted together with the sub-frame without separately transmitting the information. This makes it possible to realize a driving method in which the light emission intensity is increased in the short-distance ranging and the light emission intensity is decreased in the long-distance ranging.

Although the intensity and wavelength of the light source have been described as examples of the light source information in the present embodiment, the light source information is not limited thereto. For example, the light source information may be information related to the incident light, such as a pulse width of the emitted light, transmittance of an optical filter, and the type of the optical filter.

### Fourth Embodiment

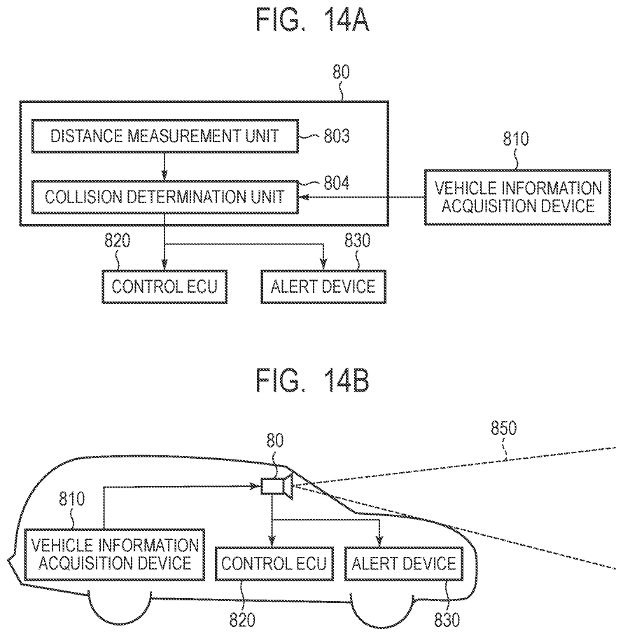

FIGS. 14A and 14B are block diagrams of equipment relating to an in-vehicle ranging device according to the present embodiment. Equipment 80 includes a distance measurement unit 803, which is an example of the distance image generation device of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that acquires distance information to the object. That is, the distance information is information on a distance to the object or the like. The collision determination unit 804 may determine the collision possibility using the distance information.

The equipment 80 is connected to a vehicle information acquisition device 810, and can acquire vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area, by the equipment 80. FIG. 14B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present invention is not limited to the above embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present invention.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A≠B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that any of the embodiments described above is merely an example of an embodiment for carrying out the present invention, and the technical scope of the present invention should not be construed as being limited by the embodiments. That is, the present invention can be carried out in various forms without departing from the technical idea or the main features thereof.

According to the present invention, a photoelectric conversion device and a signal processing device with a simplified device configuration are provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-206410, filed Dec. 23, 2022, which is hereby incorporated by reference herein in its entirety.

What is claimed is:

1. A photoelectric conversion device comprising:
a plurality of photoelectric conversion elements;
an acquisition unit configured to acquire a micro-frame constituted by a one-bit signal based on incident light to each of the plurality of photoelectric conversion elements;
a compositing unit configured to composite a plurality of the micro-frames to generate a sub-frame constituted by a multi-bit signal; and
an attribute information addition unit configured to add, to the sub-frame, attribute information corresponding to an acquisition condition of the sub-frame,
wherein acquisition conditions of at least two sub-frames among a plurality of sub-frames used for one ranging frame are different from each other.

2. The photoelectric conversion device according to claim 1, wherein the acquisition condition includes a compositing condition of the plurality of micro-frames used for generating the sub-frame.

3. The photoelectric conversion device according to claim 2, wherein the attribute information includes information indicating the number of the plurality of micro-frames composited when one sub-frame is generated.

4. The photoelectric conversion device according to claim 1, wherein the acquisition condition includes a light receiving condition of the incident light in generation of each of the plurality of micro-frames.

5. The photoelectric conversion device according to claim 4, wherein the attribute information includes information indicating a time from emission of the incident light to reception of the incident light in acquisition of the plurality of micro-frames used for generating the sub-frame.

6. The photoelectric conversion device according to claim 4, wherein the attribute information includes information indicating a length of a light receiving period of the incident light in acquisition of the plurality of micro-frames used for generating the sub-frame.

7. The photoelectric conversion device according to claim 1, wherein the acquisition condition includes a light emission condition of a light source configured to emit the incident light.

8. The photoelectric conversion device according to claim 7, wherein the attribute information includes information indicating an emission intensity of the light source.

9. The photoelectric conversion device according to claim 7, wherein the attribute information includes information indicating an emission wavelength of the light source.

10. The photoelectric conversion device according to claim 1, wherein in one sub-frame, data of the attribute information is added before data of output signals from the plurality of photoelectric conversion elements.

11. The photoelectric conversion device according to claim 1, wherein in one sub-frame, data of the attribute information is added after data of output signals from the plurality of photoelectric conversion elements.

12. The photoelectric conversion device according to claim 1,
wherein the plurality of photoelectric conversion elements are arranged to form a plurality of rows, and
wherein in one sub-frame, data of the attribute information is added between data of an output signal from a photoelectric conversion element of a first row among the plurality of rows and data of an output signal from a photoelectric conversion element of a second row next to the first row.

13. A ranging device comprising:
the photoelectric conversion device according to claim 1; and
a distance information generation unit configured to generate distance information based on the sub-frame output from the photoelectric conversion device and the attribute information added to the sub-frame.

14. A movable body comprising:
the ranging device according to claim 13; and
a movable body control unit configured to control the movable body based on the distance information acquired by the ranging device.

15. A signal processing device comprising:
a storage unit configured to store a sub-frame constituted by a multi-bit signal and generated by compositing a plurality of micro-frames constituted by a one-bit signal based on incident light to a photoelectric conversion element;
a distance information generation unit configured to generate distance information based on the sub-frame,
wherein attribute information corresponding to an acquisition condition of the sub-frame is added to the sub-frame, and
wherein acquisition conditions of at least two sub-frames among a plurality of sub-frames used for one ranging frame are different from each other.

16. The signal processing device according to claim 15, wherein the storage unit secures a memory area for storing the sub-frame based on the attribute information.

17. The signal processing device according to claim 16, wherein the attribute information includes information indicating a bit depth.

18. The signal processing device according to claim 17, wherein the multi-bit signal constituting the sub-frame is normalized based on the bit depth.

19. The signal processing device according to claim 15, wherein the distance information generation unit generates the distance information further based on the attribute information.

20. The signal processing device according to claim 19, wherein the attribute information includes information indicating a correspondence relationship between the sub-frame and a distance.

21. The signal processing device according to claim 19, wherein the attribute information includes information indicating an emission intensity of a light source emitting the incident light.

22. The signal processing device according to claim 21, wherein the distance information generation unit calculates a correction amount based on the light emission intensity and corrects the sub-frame.
